(19) United States
(12) Patent Application Publication
(10) Pub. No.: US 2021/0186264 A1
(43) Pub. Date: Jun. 24, 2021

(54) INTEGRATED PAN AND SPATULA SYSTEM

(71) Applicant: Moises Nevarez, Wrightwood, CA (US)

(72) Inventor: Moises Nevarez, Wrightwood, CA (US)

(21) Appl. No.: 17/088,617

(22) Filed: Nov. 4, 2020

Related U.S. Application Data
(60) Provisional application No. 62/949,632, filed on Dec. 18, 2019.

(51) Int. Cl. A47J 37/10; A47J 43/28

(52) U.S. Cl. CPC A47J 37/10; A47J 43/287; A47J 43/288

(57) ABSTRACT

An integrated pan and spatula system; the integrated pan and spatula system including a cooking vessel and a removably attachable cooking utensil. The cooking utensil includes a handle, a cooking-utensil-head, and cooking-utensil-locking-assembly. The cooking vessel features an inner cooking surface encompassed by a sidewall, a bottom plane including a slot configured to receive the cooking-utensil-head through an open-end of the slot, and a pan-locking-assembly. The pan-locking-assembly and the cooking-utensil-locking-assembly have mating portions and are configured to removably interlock and secure the cooking-utensil-head within the slot of the cooking vessel.

### CROSS-REFERENCE TO RELATED APPLICATION(S)

The present application is related to and claims priority to U.S. Provisional Patent Application No. 62/949,632 filed Dec. 18, 2019, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of cooking utensils of existing art and more specifically relates to a unique cooking utensil and pan combination.

### RELATED ART

Cooking utensils or tools, such as spoons, spatulas, dippers, meat forks and the like, are very useful in cooking to stir, mix and manipulate food within a pot or pan during the cooking process. In the process of utilizing such utensils, it is common to place the respective cooking utensil in an adjacent plate or drip dish when not being used. Often in transferring the particular utensil from the pot or pan to the drip dish, food and drippings drip from the utensil onto the stove and the surrounding cabinet area. Obviously, this is undesirable because the food and drippings on the stove and the surrounding area must be removed and the area cleaned. In addition, it is troublesome and inconvenient to transfer the cooking utensil being used to and from a drip dish between uses. Furthermore, it is common to store various cooking utensils such as stirring spoons and spatulas in a utensil drawer. Often it is awkward and inconvenient to gain access to a particular cooking utensil in a utensil drawer. A suitable solution is desired.

U.S. Pat. No. 4,231,128 to Donald E. James relates to a cooking utensil with integrally formed pot attaching means. The described cooking utensil with integrally formed pot attaching means includes a cooking utensil or tool basically characterized as having a handle end, a working end, and an intermediate shank portion extending between said handle and working ends. Attaching means is formed about the intermediate shank portion of the cooking tool that enables the cooking tool to be secured or rested in a firm and stationary position about the upper edge of practically all cooking pots and pans known. In addition, an associated wall hanger assembly is provided for supporting a plurality of said cooking utensils in side-by-side relationship when not in use.

### SUMMARY OF THE INVENTION

In view of the foregoing disadvantages inherent in the known cooking utensil art, the present disclosure provides a novel integrated pan and spatula system. The general purpose of the present disclosure, which will be described subsequently in greater detail, is to provide an efficient and effective integrated pan and spatula system.

An integrated pan and spatula system is disclosed herein. The integrated pan and spatula system includes an integrated pan and spatula assembly including a cooking utensil such as a spatula and a cooking vessel such as but not limited to a pan. The cooking utensil comprises a handle, a cooking-utensil-head, and a cooking-utensil-locking-assembly. The cooking vessel comprises an inner cooking surface encompassed by a sidewall, a bottom plane including a slot configured to receive the cooking-utensil-head through an open-end of the slot, and a pan-locking-assembly. The pan-locking-assembly and the cooking-utensil-locking-assembly comprise mating portions and are configured to removably interlock and secure the cooking-utensil-head within the slot of the cooking vessel.

Speaking more specifically, the pan-locking-assembly includes a first-tab and a second-tab extending from an exterior portion of the sidewall of the cooking vessel. The cooking-utensil-locking-assembly includes a wedge indentation in alignment to, and for contact with, the first-tab and the second-tab. The pan-locking-assembly further includes a first-arc-tab and a second-arc tab positioned directly below the first-tab and the second-tab. The first-arc-tab and the second-arc tab function as a latch and include a receiving indentation positioned therebetween. The cooking-utensil-locking-assembly further includes a securing knob having a first-projecting-tab and a second-projecting-tab configured to rotate and engage with the first-arc-tab and the second-arc tab of the pan-locking-assembly. The securing knob is configured to rotate alternately between a locked condition and an unlocked condition. Additionally, the cooking-utensil-locking-assembly comprises a projection member for engaging with the receiving indentation. The projection member and the receiving indentation comprise mating shaped profiles.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an integrated pan and spatula system, constructed and operative according to the teachings of the present disclosure.

FIG. 1 is a top perspective view of the integrated pan and spatula system of FIG. 1, showing an integrated pan and spatula assembly including a cooking utensil and a cooking vessel during an ‘engaged-condition’ according to an embodiment of the present disclosure.

FIG. 2 is a perspective view of the integrated pan and spatula system during an ‘in-use’ condition, according to an embodiment of the disclosure.

FIG. 3 is a perspective view of the integrated pan and spatula system of FIG. 1, including the cooking utensil having a cooking-utensil-locking-assembly and the cooking vessel having a pan-locking-assembly according to an embodiment of the present disclosure.

FIG. 4 is a perspective view of the integrated pan and spatula system of FIG. 1, including the cooking vessel having a slot for removably receiving the cooking utensil according to an embodiment of the present disclosure.

FIG. 5A is a front view of the integrated pan and spatula system of FIG. 1, showing a securing knob during a ‘locked condition’ according to an embodiment of the present disclosure.

FIG. 5B is a front view of the integrated pan and spatula system of FIG. 1, showing the securing knob during an ‘unlocked condition’ according to an embodiment of the present disclosure.

FIG. 6 is a perspective view of the integrated pan and spatula system of FIG. 1, according to an embodiment of the present disclosure.

FIG. 7 is a bottom perspective view of the integrated pan and spatula system of FIG. 1, according to an embodiment of the present disclosure.

FIG. 8 is a perspective view of the integrated pan and spatula system of FIG. 1, including the cooking vessel having a gripping nodule according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a cooking utensil and pan combination and more particularly to an integrated pan and spatula system as used to maintain cleanliness and improve the use of cooking utensils and cooking vessels by providing a combination unit.

Generally, the integrated pan and spatula system includes a pan, and a removable handle that securely attaches to, and can be easily removed from, said pan. The handle features a spatula blade at one (1) end, and the blade fits within a slot located on a bottom plane of the aforementioned cooking vessel. The handle securely attaches to, and can be easily removed from, the pan or other cooking vessel. The cooking vessel and interior of the slot is preferably coated with ceramic. The slot of the integrated pan and spatula system can gather and collect any food particles that may cling to the spatula. The integrated pan and spatula system allows for two needed and often-used cookware necessities, a frying pan and spatula, to be obtained with a single unit.

More specifically, the pan of the integrated pan and spatula system features two tabs that project in alignment from an exterior portion of the sidewall. The spatula handle of the integrated pan and spatula system features a wedge indentation in alignment to, and for contact with, these two projecting tabs. The cooking pan of the integrated pan and spatula system also features two projecting arc tabs that function as a latch, directly below the previously mentioned tabs. The spatula handle of the integrated pan and spatula system features a securing knob aligned with, and for rotating frictional attachment to the latch. The integrated pan and spatula system includes a projecting cylinder with indentation between its latch tabs. The spatula handle of the integrated pan and spatula system includes a projection of the same shape as the indentation in the projecting cylinder, and which enters said indentation upon connection of the handle to the pan.

In one embodiment, the integrated pan and spatula system is a ten-inch (10″) frying pan, made of anodized aluminum, with a rectangular-shaped nodule projecting from the top edge of the sidewall. The nodule is coated in a heat-resistant silicone. On the bottom plane of the pan is an extending slot, open at one (1) end, and ends at the center point of this bottom plane. The slot measures approximately four and one-quarter inches in length by three and one-quarter inches in width by one-quarter of one inch in height (4¼×3¼×¼″). This slot features an internal ceramic coating.

Featured on the bottom plane of the cooking pan are radial patterns of a quarter-inch (¼″) height. On the exterior sidewall of this pan are two (2) projecting tabs. Directly below the tabs are two (2) projecting arcs for function as a latch. Directly between the latch-forming projecting arcs is a projecting cylinder. Directly in the center facing of this cylinder is an asterisk-shaped indentation in preferred embodiments. The handle of the integrated pan and spatula system is formed from stainless steel and features a silicon sleeve over the gripping area. The spatula blade is of an approximate four-inch length by three-inch width by one-eighth of an inch depth (4″×3″×⅛″). In the arced neck of the handle, between the gripping area and the spatula blade, is a wedge, positioned for contact with the projecting tabs of the pan. Directly below that wedge is a securing knob, positioned for contact with and placement between the projecting arcs of the cooking pan. Projecting from the back plane of the securing knob's support wall is an asterisk-shaped projection for application within the indentation of similar shape on the pan-hosted cylinder.

The integrated pan and spatula system can be made in various frying pan sizes and shapes. The integrated pan and spatula system can be made in many varieties of cooking vessels, including but not limited to pots, pans, skillets, woks, broilers and other cookware forms. The integrated pan and spatula system may feature various other cooking utensils instead of a spatula blade, such as but not limited to a spoon, slotted spoon, stirrer, fork, and other utensils. The integrated pan and spatula system may also be made in variations in which the utensil heads are removable and attachable, and in which various types of heads.

A method of using the integrated pan and spatula system is as follows: A user may attach the handle to the cooking pan by sliding the spatula into its hosting chamber on the bottom plane of the cooking pan. After aligning the wedge of the handle with the projecting tabs of the cooking pan, the user may ensure the asterisk-shaped projection fully inserts into its host, and then turn the securing knob to firmly attach the handle. The integrated pan and spatula system may then be used like any ordinary frying pan. When the spatula is needed, and before the pan gets hot, the user may turn the securing knob to unsecure the handle, then withdraw it from the pan. The handle can then be used as a spatula as needed. When the spatula is not in active need it can be hosted within the slot on the bottom of the pan without securing the knob upon the latch. After spatula use, the handle may be reattached and re-secured to the cooking pan. When cooking is complete and after cleaning the integrated pan and spatula system, if needed, the handle may rest within the cooking pan for storage in reduced space.

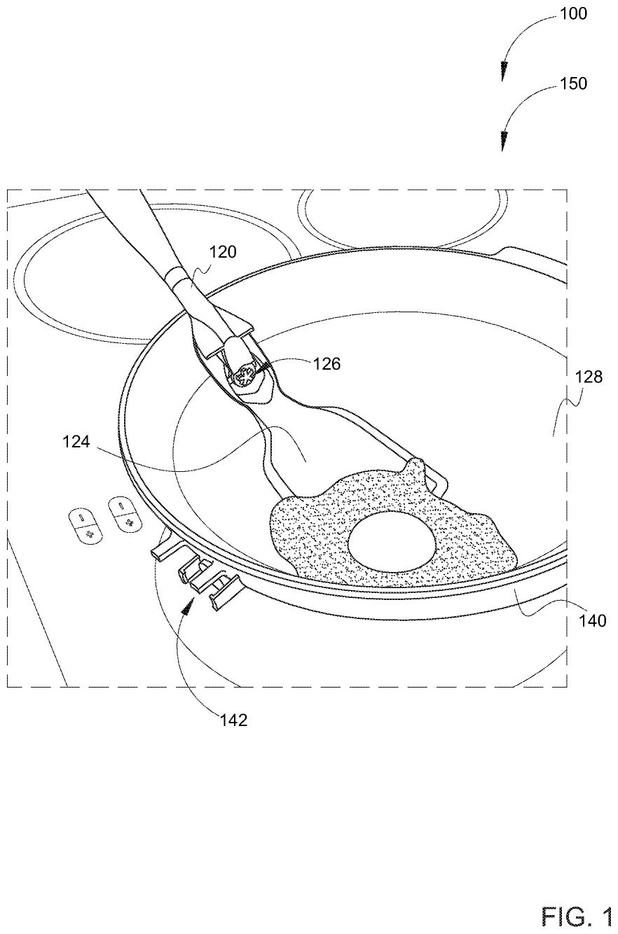

Referring now more specifically to the drawings by numerals of reference, there is shown in FIGS. 1-8, various views of an integrated pan and spatula system 100. FIG. 1 shows an integrated pan and spatula system during an ‘in-use’ condition 150, according to an embodiment of the present disclosure. As illustrated, the integrated pan and spatula system 100 may include an integrated pan and spatula assembly 110 including a cooking utensil 120 and a cooking vessel 140.

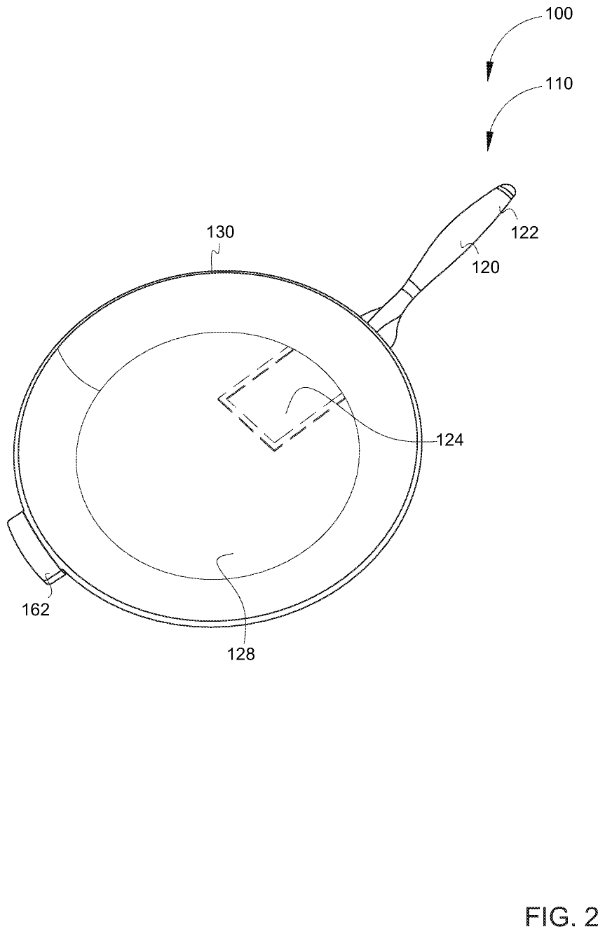

FIG. 2 is a top perspective view of the integrated pan and spatula system 100 of FIG. 1, showing the integrated pan and spatula assembly 110 including the cooking utensil 120 and the cooking vessel 140 during an ‘engaged-condition’ according to an embodiment of the present disclosure. The cooking utensil 120 comprises a handle 122, a cooking-utensil-head 124, and a cooking-utensil-locking-assembly 126. The cooking-utensil-head 124 may be solid, slotted and/or perforated. The cooking vessel 140 comprises an inner cooking surface 128 encompassed by a sidewall 130, a bottom plane 132 including a slot 134 configured to receive the cooking-utensil-head 124 through an open-end of the slot 134, and a pan-locking-assembly 142. The inner cooking surface 128 hosts food items during heated preparation. The pan-locking-assembly 142 and the cooking-utensil-locking-assembly 126 comprise mating portions and are configured to removably interlock and secure the cooking-utensil-head within the slot of the cooking vessel 140.

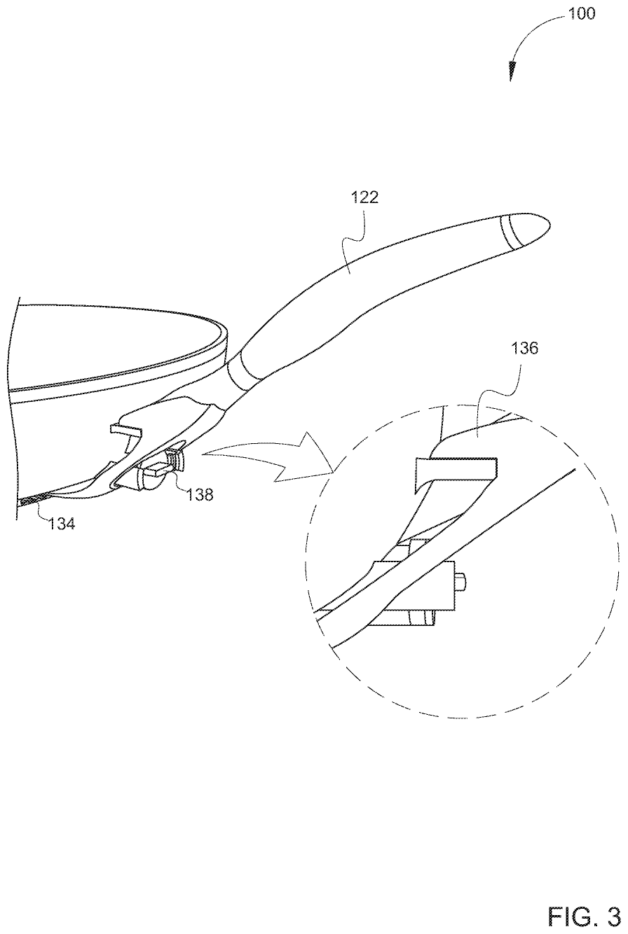

FIG. 3 is a perspective view of the integrated pan and spatula system 100 of FIG. 1, including the cooking utensil 120 having a cooking-utensil-locking-assembly 126 and the cooking vessel 140 having a pan-locking-assembly 126 according to an embodiment of the present disclosure. As shown, the pan-locking-assembly 126 includes a first-tab 143 and a second-tab 144 extending from an exterior portion of the sidewall 130 of the cooking vessel 140. The cooking-utensil-locking-assembly 126 includes a wedge indentation 136 in alignment to, and for contact with, the first-tab 143 and the second-tab 144. The pan-locking-assembly 126 further includes a first-arc-tab 145 and a second-arc tab 146 positioned directly below the first-tab 143 and the second-tab 144. The first-arc-tab 143 and the second-arc tab 144 function as a latch and include a receiving indentation 137 positioned therebetween.

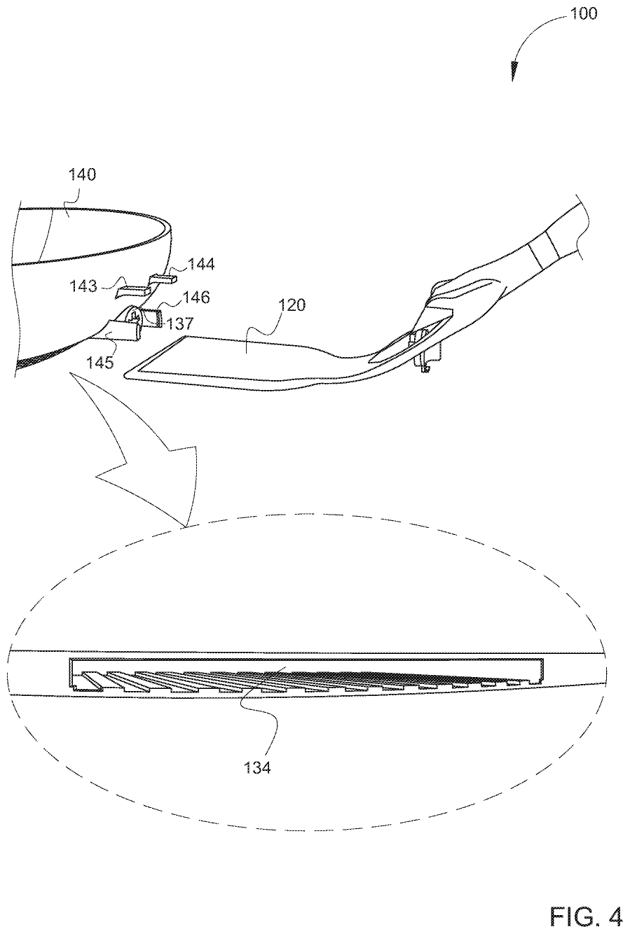

FIG. 4 is a perspective view of the integrated pan and spatula system 100 of FIG. 1, including the cooking vessel 140 comprising the slot 134 for removably receiving the cooking utensil 120 according to an embodiment of the present disclosure. The cooking vessel 140 preferably includes a ceramic coating and may be made of various materials, such as but not limited to anodized aluminum, carbon steel, stainless steel, copper and any blend of these and other materials. The slot 134 located on the bottom plane 132 of the cooking vessel 140 is sized, arranged and configured to removably receive the cooking-utensil-head 124. The slot 134 on the bottom plane 132 of the cooking vessel 140 may host a ceramic sleeve or the slot 134 may be ceramic coated and/or it may be fully ceramic. Additionally, the slot 134 may not include ceramic of any form, and in such variations may or may not include a non-stick coating within the slot 134. In certain embodiments, the integrated pan and spatula assembly 110 may be provided with a lid.

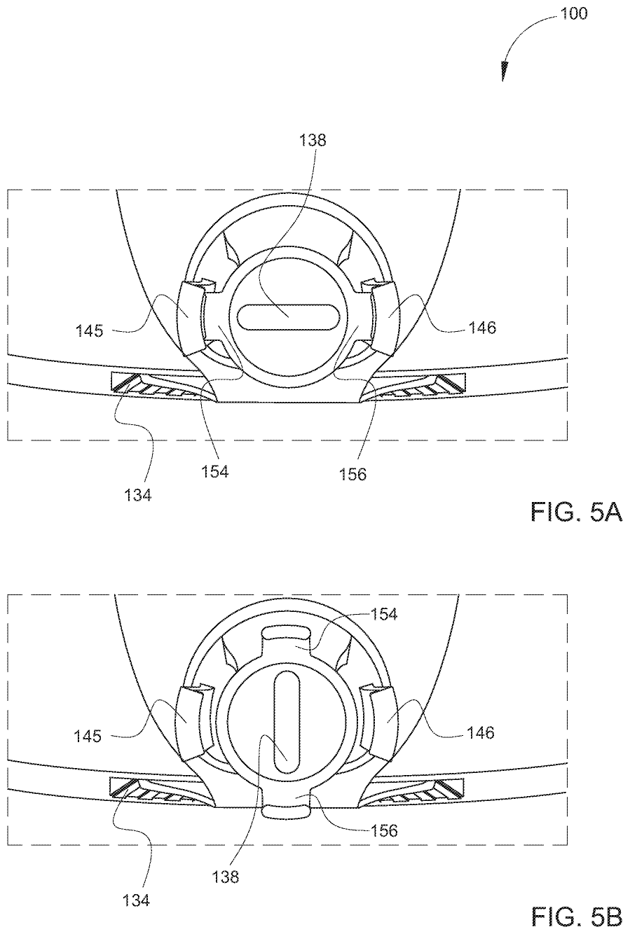

The cooking-utensil-locking-assembly 126 further includes a securing knob 138 having a first-projecting-tab 154 and a second-projecting-tab 156 configured to rotate and engage with the first-arc-tab 145 and the second-arc tab 146 of the pan-locking-assembly 142. The securing knob 138 is configured to rotate alternately between a locked condition and an unlocked condition. FIG. 5A is a front view of the integrated pan and spatula system 100 of FIG. 1, showing the securing knob 138 during a ‘locked condition’ according to an embodiment of the present disclosure. FIG. 5B is a front view of the integrated pan and spatula system 100 of FIG. 1, showing the securing knob 138 during an ‘unlocked condition’ according to an embodiment of the present disclosure.

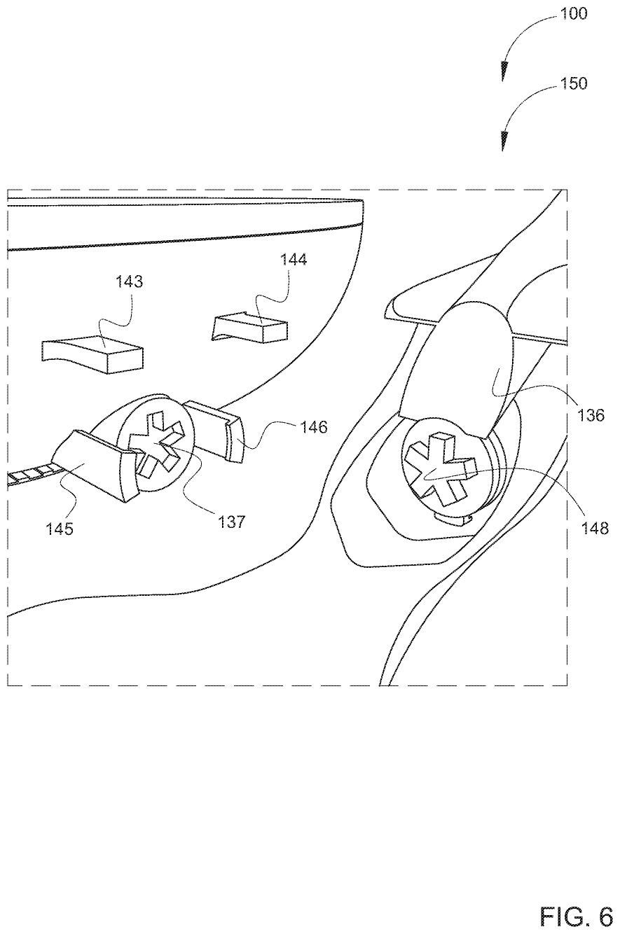

FIG. 6 is a perspective view of the integrated pan and spatula system 100 of FIG. 1, according to an embodiment of the present disclosure. As shown in FIG. 6, the cooking-utensil-locking-assembly 126 is further comprised of a projection member 148 for engaging with the receiving indentation 137 of the cooking vessel 140. The projection member 148 and the receiving indentation 137 comprise mating shaped profiles. The receiving indentation 137 and the projection member 148 may comprise an asterisk-shaped profile or other suitable profile.

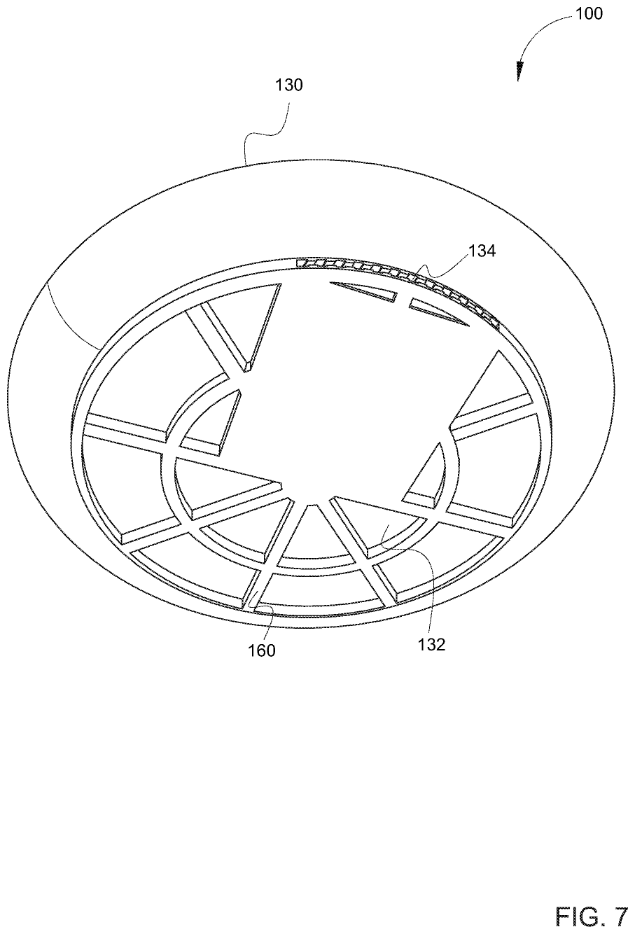

FIG. 7 is a bottom perspective view of the integrated pan and spatula system 100 of FIG. 1, according to an embodiment of the present disclosure. As shown, the bottom plane 132 of the cooking vessel 140 includes an extruded grid system 160. The extruded grid system 160 on the bottom plane 132 of the cooking vessel 140 directs heat around the cooking utensil 120 and to the inner cooking surface 128 of the cooking vessel 140. Additionally, the extruded grid system 160 ensures the cooking vessel 140 sits flush on cooking and serving surfaces. In a preferred embodiment, the cooking vessel 140 comprises a diameter of approximately 10 inches however, various sizes may be provided. The cooking-utensil 120 may include a spatula, a spoon, a slotted spoon, a stirrer, a fork, and/or other cooking utensils or tools. Additionally, the cooking vessel 140 may be provided as a pot, a pan, a skillet, a wok, a broiler, or other cooking vessel 140.

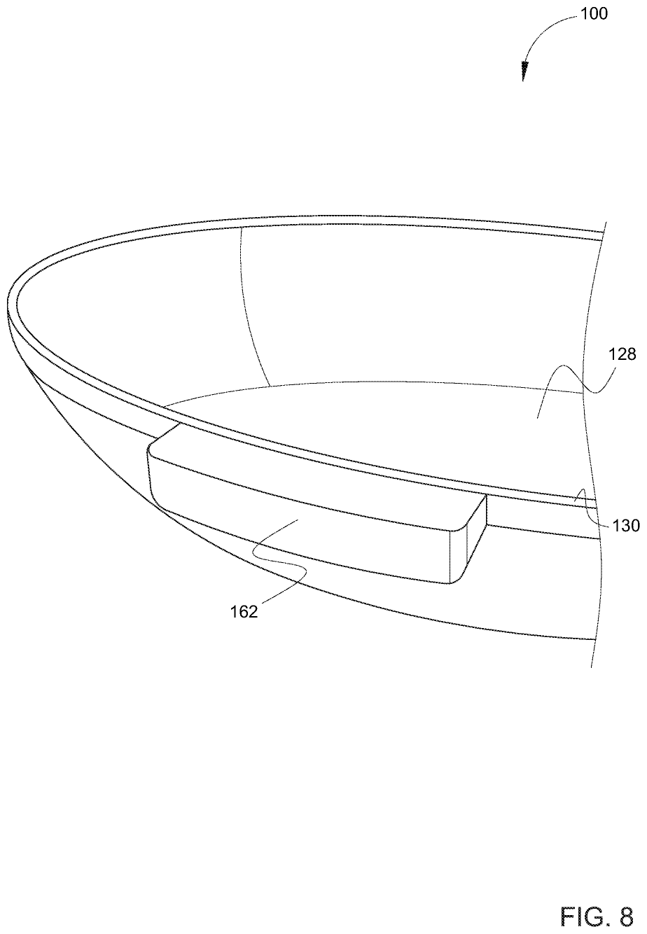

FIG. 8 is a perspective view of the integrated pan and spatula system 100 of FIG. 1, including the cooking vessel 140 having a gripping nodule 162 according to an embodiment of the present disclosure. The gripping nodule 162 preferably comprises a rectangular-shaped projection extending from the sidewall 130 of the cooking vessel 140 opposite of the pan-locking-assembly. The gripping nodule 162 is preferably coated with a heat resistant silicone material. The gripping nodule 162 of the integrated pan and spatula system 100 further enhances the ease of removing and inserting the cooking utensil 120 within the slot 134 of the cooking vessel 140. Additionally, the gripping nodule 162 may be utilized to maintain the cooking vessel 140 in a steady position while preparing food. The gripping nodule 162 of the integrated pan and spatula system 100 further enhances the ease of removing and inserting the cooking utensil 120 within the slot 134.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An integrated pan and spatula system, the system comprising:
an integrated pan and spatula assembly including;
a cooking utensil having;
a handle;
a cooking-utensil-head; and
a cooking-utensil-locking-assembly; and
a cooking vessel having;
an inner cooking surface encompassed by a sidewall;
a bottom plane including a slot configured to receive the cooking-utensil-head through an open-end of the slot; and
a pan-locking-assembly; and
wherein the pan-locking-assembly and the cooking-utensil-locking-assembly comprise mating portions and are configured to removably interlock and secure the cooking-utensil-head within the slot of the cooking vessel.

2. The integrated pan and spatula system of claim 1, wherein the pan-locking-assembly includes a first-tab and a second-tab extending from an exterior portion of the sidewall of the cooking vessel.

3. The integrated pan and spatula system of claim 2, wherein the cooking-utensil-locking-assembly includes a wedge indentation in alignment to, and for contact with, the first-tab and the second-tab.

4. The integrated pan and spatula system of claim 2, wherein the pan-locking-assembly further includes a first-arc-tab and a second-arc tab positioned directly below the first-tab and the second-tab.

5. The integrated pan and spatula system of claim 4, wherein the first-arc-tab and the second-arc tab function as a latch and include a receiving indentation positioned therebetween.

6. The integrated pan and spatula system of claim 5, wherein the cooking-utensil-locking-assembly is further comprised of a projection member for engaging with the receiving indentation, the projection member and the receiving indentation comprising mating shaped profiles.

7. The integrated pan and spatula system of claim 6, wherein the receiving indentation and the projection member comprise an asterisk-shaped profile.

8. The integrated pan and spatula system of claim 6, wherein the cooking-utensil-locking-assembly further includes a securing knob having a first-projecting-tab and a second-projecting-tab configured to rotate and engage with the first-arc-tab and the second-arc tab of the pan-locking-assembly.

9. The integrated pan and spatula system of claim 8, wherein the securing knob is configured to rotate alternately between a locked condition and an unlocked condition.

10. The integrated pan and spatula system of claim 1, wherein the cooking vessel further includes a gripping nodule.

11. The integrated pan and spatula system of claim 10, wherein the gripping nodule comprises a rectangular-shaped projection extending from the sidewall of the cooking vessel opposite of the pan-locking-assembly.

12. The integrated pan and spatula system of claim 11, wherein the gripping nodule is coated with a heat resistant silicone material.

13. The integrated pan and spatula system of claim 1, wherein the bottom plane of the cooking vessel includes an extruded grid system.

14. The integrated pan and spatula system of claim 1, wherein the cooking vessel comprises a diameter of approximately 10 inches.

15. The integrated pan and spatula system of claim 1, wherein the cooking vessel includes a ceramic coating.

16. The integrated pan and spatula system of claim 1, wherein the slot located on the bottom plane of the cooking vessel is sized, arranged and configured to removably receive the cooking-utensil-head and comprises a ceramic coating

17. The integrated pan and spatula system of claim 1, wherein the cooking utensil is selected from the group consisting of a spatula, a spoon, a slotted spoon, a stirrer, and a fork.

18. The integrated pan and spatula system of claim 1, wherein the cooking vessel is selected from the group consisting of a pot, a pan, a skillet, a wok, and a broiler.

19. The integrated pan and spatula system of claim 1, wherein the integrated pan and spatula assembly further includes a lid.

20. An integrated pan and spatula system, the integrated pan and spatula system comprising:
an integrated pan and spatula assembly including;
a cooking utensil having;
a handle;
a cooking-utensil-head; and
a cooking-utensil-locking-assembly; and
a cooking vessel having;
an inner cooking surface encompassed by a sidewall;
a bottom plane including a slot configured to receive the cooking-utensil-head through an open-end of the slot; and
a pan-locking-assembly;
wherein the pan-locking-assembly and the cooking-utensil-locking-assembly comprise mating portions and are configured to removably interlock and secure the cooking-utensil-head within the slot of the cooking vessel;
wherein the pan-locking-assembly includes a first-tab and a second-tab extending from an exterior portion of the sidewall of the cooking vessel;
wherein the cooking-utensil-locking-assembly includes a wedge indentation in alignment to, and for contact with, the first-tab and the second-tab;
wherein the pan-locking-assembly further includes a first-arc-tab and a second-arc tab positioned directly below the first-tab and the second-tab;
wherein the first-arc-tab and the second-arc tab function as a latch and include a receiving indentation positioned therebetween;
wherein the cooking-utensil-locking-assembly is further comprised of a projection member for engaging with the receiving indentation, the projection member and the receiving indentation comprising mating shaped profiles;
wherein the receiving indentation and the projection member comprise an asterisk-shaped profile;
wherein the cooking-utensil-locking-assembly further includes a securing knob having a first-projecting-tab and a second-projecting-tab configured to rotate and engage with the first-arc-tab and the second-arc tab of the pan-locking-assembly;
wherein the securing knob is configured to rotate alternately between a locked condition and an unlocked condition;
wherein the cooking vessel further includes a gripping nodule;
wherein the gripping nodule comprises a rectangular-shaped projection extending from the sidewall of the cooking vessel opposite of the pan-locking-assembly;
wherein the gripping nodule is coated with a heat resistant silicone material;
wherein the bottom plane of the cooking vessel includes an extruded grid system;
wherein the cooking vessel includes a ceramic coating; and
wherein the slot located on the bottom plane of the cooking vessel is sized, arranged and configured to removably receive the cooking-utensil-head and comprises a ceramic coating.
